(19) United States
(12) Patent Application Publication
(10) Pub. No.: US 2026/0179103 A1
(43) Pub. Date: Jun. 25, 2026

(54) Intelligent carbon emission calculation system

(71) Applicant: ADATA TECHNOLOGY CO., LTD., Taipei City (TW)

(72) Inventors: YU SYUAN TSAI, New Taipei City (TW); POCHUN YEN, Taipei City (TW)

(21) Appl. No.: 19/002,499

(22) Filed: Dec. 26, 2024

(30) Foreign Application Priority Data
Dec. 25, 2024 (TW) 113150773

(51) Int. Cl. G06Q 30/018

(52) U.S. Cl. CPC G06Q 30/018

(57) ABSTRACT

An intelligent carbon emission calculation system is provided, which includes a vehicle data collection module, an environmental data acquisition module, a charging station data collection module, a data fusion processing module, a carbon emission calculation module, and a carbon emission optimization suggestion module, wherein the vehicle data collection module collects real-time vehicle operation data, the environmental data acquisition module obtains operating route environmental data, the charging station data collection module collects charging station power grid data, the data fusion processing module processes the real-time vehicle operation data, operating route environment data, and charging station power grid data to obtain fused data, the carbon emission calculation module inputs the fusion data into the carbon emission prediction model to generate calculation results, and the carbon emission optimization suggestion module generates optimization suggestions based on the calculation results of the carbon emission prediction model.

### CROSS-REFERENCE TO RELATED PATENT APPLICATION

This application claims priority to Taiwan Patent Application No. 113150773, filed on Dec. 25, 2024. The entire contents of Taiwan Patent Application No. 113150773 is incorporated herein by reference.

### FIELD OF THE INVENTION

The present invention relates to carbon emission calculation technologies, particularly an intelligent carbon emission calculation system designed specifically for electric vehicles.

### BACKGROUND OF THE INVENTION

Currently, vehicle carbon emission calculations mostly target the overall vehicle life cycle, including stages such as raw material acquisition, vehicle production, energy use, maintenance, and disposal. However, according to the existing methods, it is difficult to propose targeted measures to reduce carbon emissions during the vehicle design phase. Therefore, there is a need for a system that can effectively control carbon emissions during the design and development process.

### SUMMARY OF THE INVENTION

The present invention provides an intelligent carbon emission calculation system for electric vehicles, which accurately estimates and controls the carbon footprint using a modular method during the design phase, thereby proposing design optimization suggestions to reduce carbon emissions during the entire life cycle.

To achieve one, some, or all of the above objectives or other objectives, an embodiment of the present invention provides an intelligent carbon emission calculation system, including a vehicle data collection module, an environmental data acquisition module, a charging station data collection module, a data fusion processing module, a carbon emission calculation module, and a carbon emission optimization suggestion module. The data fusion processing module is coupled to the vehicle data collection module, the environmental data acquisition module, and the charging station data collection module. The carbon emission calculation module is coupled to the data fusion processing module, and the carbon emission optimization suggestion module is coupled to the carbon emission calculation module. In addition, the vehicle data collection module is configured to collect real-time vehicle operation data, the environmental data acquisition module is configured to acquire operating route environment data, the charging station data collection module is configured to collect charging station power grid data, the data fusion processing module is configured to process the real-time vehicle operation data, operating route environment data, and charging station power grid data to obtain fused data, the carbon emission calculation module is configured to input the fused data into the carbon emission prediction model to generate calculation results, and the carbon emission optimization suggestion module is configured to generate optimization suggestions based on the calculation results of the carbon emission prediction model.

In an embodiment of the present invention, the real-time vehicle operation data includes route, vehicle speed, energy consumption, load, and mileage.

In an embodiment of the present invention, the operating route environment data includes congestion level, slope, wind speed, and temperature.

In an embodiment of the present invention, the charging station power grid data includes charging station location, charging efficiency, and grid carbon emission factor.

In an embodiment of the present invention, the optimization suggestions include an adapted route and a charging suggestion for each vehicle, and/or a vehicle model and a delivery sequence for each delivery.

In an embodiment of the present invention, the intelligent carbon emission calculation system further includes a database, which is coupled to the vehicle data collection module, the environmental data acquisition module, the charging station data collection module, the data fusion processing module, the carbon emission calculation module, and the carbon emission optimization suggestion module, and is configured to store real-time vehicle operation data, operating route environment data, charging station power grid data, fused data, calculation results, and optimization suggestions.

The present invention achieves intelligent and accurate calculation of carbon emissions of vehicles during the overall life cycles through multi-data fusion with a carbon emission prediction model, providing data support for low-carbon operational decisions for transportation enterprises.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a system block diagram of an intelligent carbon emission calculation system according to an embodiment of the present invention.

### DETAILED DESCRIPTION OF PREFERRED EMBODIMENTS

The present invention is particularly described with the following examples, which are merely for illustration. For those skilled in the art, various modifications and refinements can be made without departing from the spirit and scope of this disclosure. Therefore, the scope of protection of this disclosure shall be defined by the appended claims. Throughout the specification and claims, unless clearly specified otherwise, the meaning of “a” and “the” includes “one or at least one” element or component. In addition, as used in the present invention, unless it is clearly apparent from the context that the plural is excluded, the singular also includes the plural elements or components. Additionally, when used in this description and all the following claims, unless clearly specified otherwise, “therein” can mean “in” and “on”. The terms used throughout this specification and claims, unless specifically noted, usually have their ordinary meanings in the field, in the context of this disclosure, and in the specific context. Some terms used to describe the present invention will be discussed below or elsewhere in this specification to provide additional guidance to a practitioner regarding the description of the present invention. Any examples given anywhere throughout the specification, including the use of any terms discussed herein, are merely for description and do not limit the scope and meaning of the present invention or any exemplified terms. Likewise, the present invention is not limited to the various embodiments proposed in this specification.

Furthermore, if a term “coupled” or “connected” is used herein, it includes any direct and indirect electrical connection measures. For example, a text describes that a first apparatus is electrically coupled to a second apparatus, meaning that the first apparatus may be connected to the second apparatus directly or indirectly via through other apparatuses or connection measures. Additionally, if a description involves transmission or provision of electrical signals, those skilled in the art should understand that the transmission of electrical signals may be accompanied by attenuation or other non-ideal changes, but unless specifically stated otherwise, the electrical signals transmitted or provided from sources to receiving ends should be considered as substantially the same signal. For example, in a case that an electrical signal S is transmitted (or provided) from an endpoint A of an electronic circuit to an endpoint B, where it may pass by the source and drain terminals of a transistor switch and/or a possible stray capacitor, causing a voltage drop, but if the objective of such design is not to intentionally use the attenuation or other non-ideal changes during transmission (or provision) to achieve certain technical effects, the electrical signal S at the endpoint A and the electrical signal S at the endpoint B of the electronic circuit should be considered substantially the same signal.

It can be understood that the terms “comprising,” “including,” “having,” “containing,” “involving,” and the like as used herein are open-ended, meaning inclusion but being not limited thereto. Additionally, any embodiment or claim of the present invention does not have to achieve all the objectives, advantages, or features disclosed in the present invention. Furthermore, the abstract and title are only for assisting in patent document searches and are not intended to limit the claims of the present invention.

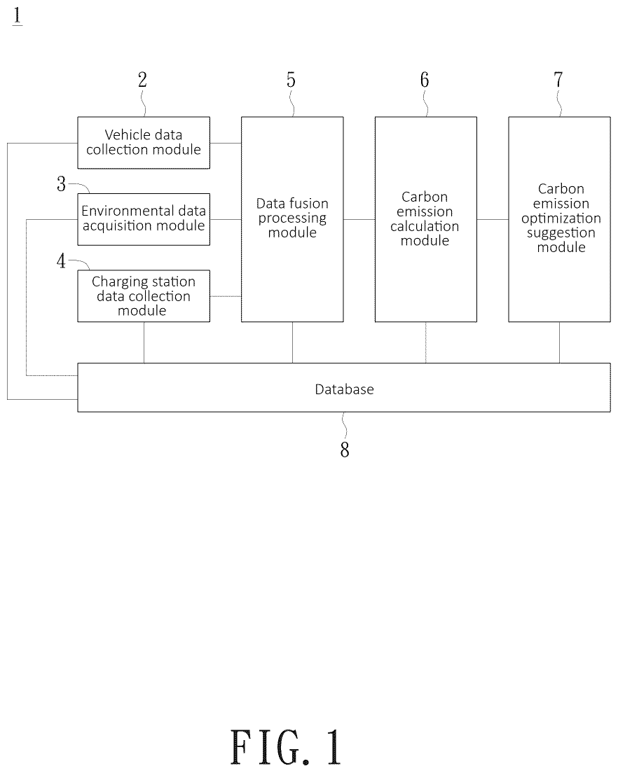

For reference, FIG. 1 is a system block diagram of an intelligent carbon emission calculation system according to an embodiment of the present invention. An intelligent carbon emission calculation system 1 provided in this embodiment includes a vehicle data collection module 2, an environmental data acquisition module 3, a charging station data collection module 4, a data fusion processing module 5, a carbon emission calculation module 6, a carbon emission optimization suggestion module 7, and a database 8. The data fusion processing module 5 is coupled to the vehicle data collection module 2, the environmental data acquisition module 3, and the charging station data collection module 4. The carbon emission calculation module 6 is coupled to the data fusion processing module 5, the carbon emission optimization suggestion module 7 is coupled to the carbon emission calculation module 6, and the database 8 is coupled to the vehicle data collection module 2, the environmental data acquisition module 3, the charging station data collection module 4, the data fusion processing module 5, the carbon emission calculation module 6, and the carbon emission optimization suggestion module 7.

Additionally, the vehicle data collection module 2 is configured to collect real-time vehicle operation data, where the real-time vehicle operation data includes route, vehicle speed, energy consumption, load, mileage, and the like. The environmental data acquisition module 3 is configured to acquire operating route environment data, where the operating route environment data includes congestion level, slope, wind speed, temperature, and the like. The charging station data collection module 4 is configured to collect charging station power grid data, where the charging station power grid data includes charging station location, charging efficiency, grid carbon emission factor, and the like. The data fusion processing module 5 is configured to process, for example, cleaning or standardizing of real-time vehicle operation data, operating route environment data, and charging station power grid data, to obtain fused data. The carbon emission calculation module 6 is configured to input the fused data into a carbon emission prediction model to generate calculation results, where the carbon emission prediction model is implemented based on a deep learning algorithm. The carbon emission optimization suggestion module 7 is configured to generate optimization suggestions based on the calculation results of the carbon emission prediction model, and to display the calculation results in the form of charts or data for designers to reference and optimize. The optimization suggestions include an adapted route and a charging suggestion for each vehicle, and/or a vehicle model and a delivery sequence for each delivery. The database 8 is configured to store real-time vehicle operation data, operating route environment data, charging station power grid data, fused data, calculation results, and optimization suggestions.

It should be noted that those skilled in the art can design vehicle carbon emission calculation algorithms based on actual vehicle parameters, and the present invention is not limited thereto. In addition, the intelligent carbon emission calculation system 1 of this embodiment can integrate vehicle characteristics and energy consumption data to calculate the carbon emissions of each vehicle and all vehicles, achieving low-carbon optimization for short and medium-to-long distance transportation. This results in an intelligent carbon emission calculation system 1 based on the ISO 14083 framework, and this system focuses on managing electric vehicle road transportation scenarios, accurately calculates overall process carbon emissions for different vehicle characteristics with reference to vehicle data, environmental data, and charging station data, and provides suggestions for optimized transportation routes and charging strategies, improving transportation efficiency and reducing overall carbon emissions. This system also specifically introduces a carbon emission factor of 0.038 kgCO₂e/km for electric tricycles, suitable for short-distance delivery and urban logistics scenarios.

In an example, the intelligent carbon emission calculation system 1 of the present invention first collects vehicle parameters of each vehicle, such as dimension, material, and component, and integrates them into a data platform like CAD or CAE. Next, the vehicle parameters are divided into two groups. The first group includes parameters available in the existing database 8 or regulatory data, such as a battery system, an electric drive system, and an in-vehicle seating system. The second group includes parameters that cannot be directly obtained from the database 8, such as a vehicle body structure system, a chassis system, and an accessory system. Carbon emission estimation is performed separately for the first group and second group. For example, the carbon emission of the vehicle body structure system is estimated based on a material density and a theoretical enclosed volume, with the body subdivided into multiple modules to simplify calculations. The carbon emission of the chassis system is estimated based on parameters such as vehicle wheelbase and width. The accessory system includes interior and exterior trim and electronic devices, with the carbon emission estimated based on the total volume of the vehicle. Next, the estimated carbon emission data of the two groups is stored in the database 8 to be provided to the carbon emission calculation module 6 for calculating the carbon emissions of each vehicle and all vehicles.

In summary, the intelligent carbon emission calculation system provided by the present invention achieves intelligent and accurate calculation of carbon emissions of vehicles during the overall life cycles through multi-data fusion with a carbon emission prediction model, providing data support for low-carbon operational decisions for transportation enterprises.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An intelligent carbon emission calculation system, comprising:
a vehicle data collection module, configured to collect real-time vehicle operation data;
an environmental data acquisition module, configured to acquire operating route environment data;
a charging station data collection module, configured to collect charging station power grid data;
a data fusion processing module, coupled to the vehicle data collection module, the environmental data acquisition module, and the charging station data collection module, and configured to process the real-time vehicle operation data, the operating route environment data, and the charging station power grid data to obtain fused data;
a carbon emission calculation module, coupled to the data fusion processing module, and configured to input the fused data into a carbon emission prediction model to generate calculation results; and
a carbon emission optimization suggestion module, coupled to the carbon emission calculation module, and configured to generate optimization suggestions based on the calculation results of the carbon emission prediction model.

2. The intelligent carbon emission calculation system according to claim 1, wherein the real-time vehicle operation data comprises route, vehicle speed, energy consumption, load, and mileage.

3. The intelligent carbon emission calculation system according to claim 1, wherein the operating route environment data comprises congestion level, slope, wind speed, and temperature.

4. The intelligent carbon emission calculation system according to claim 1, wherein the charging station power grid data comprises charging station location, charging efficiency, and grid carbon emission factor.

5. The intelligent carbon emission calculation system according to claim 1, wherein the optimization suggestions comprise an adapted route and a charging suggestion for each vehicle, and/or a vehicle model and a delivery sequence for each delivery.

6. The intelligent carbon emission calculation system according to claim 1, further comprising:
a database, coupled to the vehicle data collection module, the environmental data acquisition module, the charging station data collection module, the data fusion processing module, the carbon emission calculation module, and the carbon emission optimization suggestion module, and configured to store the real-time vehicle operation data, the operating route environment data, the charging station power grid data, the fused data, the calculation results, and the optimization suggestions.
